(19) United States
(12) Patent Application Publication
(10) Pub. No.: US 2008/0210900 A1
(43) Pub. Date: Sep. 4, 2008

(54) Selective Wet Etchings Of Oxides

(76) Inventors: William Wojtczak, Austin, TX (US); Sian Collins, Austin, TX (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/914,241

(22) PCT Filed: Apr. 25, 2006
(86) PCT No.: PCT/US2006/015372

§ 371 Date: Nov. 13, 2007

Related U.S. Application Data
(60) Provisional application No. 60/680,685, filed on May 13, 2005.

(51) Int. Cl. C09K 13/08; C03C 25/52

(52) U.S. Cl. 252/79.3; 216/99; 216/96

(57) ABSTRACT

The present invention relates to a wet etching composition including a sulfonic acid, a phosphonic acid, a phosphinic acid or a mixture of any two or more thereof, and a fluoride, and to a process of selectively etching oxides relative to nitrides, high-nitrogen content silicon oxynitride, metal, silicon or silicide. The process includes providing a substrate comprising oxide and one or more of nitride, high-nitrogen content silicon oxynitride, metal, silicon or silicide in which the oxide is to be etched; applying to the substrate for a time sufficient to remove a desired quantity of oxide from the substrate the etching composition; and removing the etching composition, in which the oxide is removed selectively.

### TECHNICAL FIELD

The present invention relates to wet etching of oxides, such as silicon dioxide, phosphorus-doped silicon glass (PSG), boron and phosphorus doped silicon glass (BPSG), boron-doped silicon glass (BSG) and high-oxygen content silicon oxynitride, selective to surrounding structures or materials including nitrides, such as silicon nitride and titanium nitrides and mixtures thereof, high-nitrogen content silicon oxynitride, metals, silicon, including both polysilicon and monocrystalline silicon, suicides and photoresists.

### BACKGROUND

The lithography process generally consists of the following steps. A layer of photoresist (PR) material is first applied by a suitable process, such as spin-coating, onto the surface of the wafer. The PR layer is then selectively exposed to radiation such as ultraviolet light, electrons, or x-rays, with the exposed areas defined by the exposure tool, mask or computer data. After exposure, the PR layer is subjected to development which destroys unwanted areas of the PR layer, exposing the corresponding areas of the underlying layer. Depending on the resist type, the development stage may destroy either the exposed or unexposed areas. The areas with no resist material left on top of them are then subjected to additive or subtractive processes, allowing the selective deposition or removal of material on the substrate. For example, a material such as a silicon oxide may be removed.

Etching is the process of removing regions of the underlying material that are no longer protected by the PR after development. The rate at which the etching process occurs is known as the etch rate. The etching process is said to be isotropic if it proceeds in all directions at the same rate. If it proceeds in only one direction, then it is anisotropic. Wet etching processes are generally isotropic.

An Important consideration in any etching process is the ‘selectivity’ of the etchant. An etchant may not only attack the material being removed, but may also attack the mask or PR and/or the substrate (the surface under the material being etched) as well. The ‘selectivity’ of an etchant refers to its ability to remove only the material intended for etching, while leaving the mask and substrate materials intact.

Selectivity, S, is measured as the ratio between the different etch rates of the etchant for different materials. Thus, a good etchant needs to have a high selectivity value with respect to both the mask (Sfm) and the substrate (Sfs), i.e., its etching rate for the film being etched must be much higher than its etching rates for both the mask and the substrate and other nearby or adjacent materials.

Etching of silicon oxides, such as silicon dioxide, phosphorus-doped silicon glass (PSG), boron and phosphorus doped silicon glass (BPSG), boron-doped silicon glass (BSG) and silicon oxynitride, has conventionally been carried out using, e.g., an aqueous solution of hydrogen fluoride, HF. Such formulations effectively etch such silicon oxides but also tend to unduly etch surrounding structures formed of materials such as nitrides (and particularly nitrides such as HCD and/or DCS nitride), metals, silicon and suicide, and may also swell and/or etch the PR as well as reduce the adhesion of the PR to the wafer surface.

A long-standing problem with using these conventional wet oxide etchants is their lack of selectivity. These etchants often attack surrounding structures, resulting in either an undesirable or unacceptable degree of etching or, particularly in the case of some photoresists, swelling and/or loss of adhesion to substrates to which the photoresist is applied. Such lack of selectivity becomes less and less acceptable as critical dimensions continue to be reduced.

Selective wet-etch compositions are important to device design and manufacturing for the most advanced semiconductor technologies. Such process chemicals are needed for both new device architecture and critical dimension reduction. Accordingly, a need exists, particularly in the semiconductor industry, for more selective wet etching compositions and processes using the compositions for removal of silicon oxides such as those mentioned above, selective to surrounding structures such as nitrides, high-nitrogen content silicon oxynitride, metals, silicon, suicides, photoresists and other materials with which the etching composition comes in contact during the etching process.

### SUMMARY

In accordance with one embodiment of the present invention, there is provided a wet etching composition including a sulfonic acid, a phosphonic acid, a phosphinic acid or a mixture of any two or more thereof, and a fluoride. Additional features of the composition are set forth below.

In accordance with another embodiment of the present invention, there is provided a process of selectively etching oxide relative to nitride, metals, silicon or silicide, including steps of:

providing a substrate comprising oxide and one or more of nitride, metal, silicon or silicide in which the oxide is to be etched;

applying to the substrate for a time sufficient to remove a desired quantity of oxide from the substrate an etching composition comprising:
a sulfonic acid, a phosphonic acid, a phosphinic acid or a mixture of any two or more thereof; and
a fluoride; and

removing the etching composition,

wherein the oxide is removed selective to the one or more of nitride, metal, silicon or silicide.

In one embodiment, the etching composition is applied at a temperature in the range from about 15° C. to about 60° C. In one embodiment, the etching composition is removed by washing with a rinse composition comprising water and/or a solvent. In one embodiment, the oxide is removed at a rate greater than about 1500 angstroms/minute at a temperature of about 20° C. Additional features of the process are set forth below.

Thus, the present invention addresses the problem of providing selective wet etchants and a process of use thereof for removal of silicon oxides such as those mentioned above, selective to surrounding structures such as nitrides, high-nitrogen content silicon oxynitride, metals, silicon, silicides, photoresists and other materials.

### BRIEF DESCRIPTION OF THE DRAWINGS

FIG. 1 is a drawing depicting the etching of both oxide and surrounding structures using etching compositions with low selectivity.

FIG. 2 is a drawing depicting the selective etching of oxide with respect to surrounding structures using an etching composition in accordance with the present invention.

FIG. 3 is a graph illustrating the PSG and nitride etch rate and selectivity versus PSG bath loading in accordance with an embodiment of the present invention.

It should be appreciated that for simplicity and clarity of illustration, elements shown in the Figures have not necessarily been drawn to scale. For example, the dimensions of some of the elements may have been exaggerated relative to each other for clarity. Further, where considered appropriate, reference numerals have been repeated among the Figures to indicate corresponding elements.

It should be appreciated that the process steps and structures described herein do not form a complete system or process flow for carrying out an etching process, such as would be used in manufacturing a semiconductor device or other device. The present invention can be practiced in conjunction with fabrication techniques and apparatus currently used in the art, and only so much of the commonly practiced materials, apparatus and process steps are included as are necessary for an understanding of the present invention.

### DETAILED DESCRIPTION

As used herein “composition” includes a mixture of the materials that comprise the composition as well as products formed by reactions between or decomposition of the materials that comprise the composition.

As is known in the art, although there is no direct relationship, in general in wet etching, as the etch rate increases, etch selectivity decreases. While it is important to obtain a high etch rate to maintain production rates, it is of equal or greater importance to obtain high selectivity. Thus, a balance of these two desirable properties needs to be struck. Accordingly, the present invention provides a wet etching composition having a good balance between etch rate and etch selectivity for silicon oxides relative to surrounding structures such as nitrides, high-nitrogen content silicon oxynitride, metals, silicon, silicides, photoresists and other materials.

Selective wet-etch solutions are important to device design and manufacturing for the most advanced semiconductor technologies. Such process chemicals are important for both new device architecture and critical dimension reduction.

Fluoride formulations, both aqueous and non-aqueous, have been used to etch silicon oxides with varying but generally low etch selectivities relative to other materials. Such etching compositions are generally composed of a fluoride component and a solvent, typically water. Such formulations will etch oxides such as PSG at a higher rate than silicon nitride, but an improvement in the selectivity would be desirable. However, etch selectivity of PSG to nitride narrows significantly when the nitride has been deposited by methods such as a low temperature hollow cathode discharge (HCD) or DCS (dichlorosilane) CVD method. DCS-silicon nitrides behave in their etch characteristics more closely to that of thermal oxide than LPCVD silicon nitride. Selectivities of only about 10:1 to about 100:1 between PSG and DCS-silicon nitride, when etched with commercially available dilute aqueous HF or Buffered Oxide Etch (BOE), are observed. Such etch selectivities are so low as to inhibit or even rule out the use of such easily-etched nitrides.

In one embodiment, the present invention relates to a selective wet etching composition, including a sulfonic acid, a phosphonic acid, a phosphinic acid or a mixture of any two or more thereof and a fluoride.

In one embodiment, the present invention relates to an etching composition, including a sulfonic acid, a phosphonic acid, a phosphinic acid or a mixture of any two or more thereof and a fluoride and having improved etch rate and selectivity for oxides, particularly with respect to HCD and/or DCS nitride, but more generally with respect to nitrides, high-nitrogen content silicon oxynitride, metals, silicon, silicides and photoresist materials. In some embodiments, the etching compositions in accordance with the invention etch PSG at rates ranging from about 2,000 to about 15,000 angstroms per minute (Å/min) with a PSG:DCS-nitride selectivity in the range from greater than about 100:1 to about 1000:1.

FIG. 1 is a drawing depicting the etching of both oxide and surrounding structures using etching compositions with low selectivity. In FIG. 1, the structure 100 includes a substrate 102 formed of, e.g., silicon, over which is formed a layer of nitride 104. Over the layer of nitride 104 is formed a layer of oxide 106. If the structure 100 is subjected to an etch process using a non-selective wet etching composition such as aqueous HF, the layer of oxide 106 is etched away, but also portions of both the layer of nitride 104 and the substrate 102 are also etched away. The etching process in FIG. 1 is relatively non-selective. That is, in the product structure 100′, the etching completely removes the layer of oxide 106, but it also etches away portions of the layer of nitride 104 and the substrate 102 which are not intended to be etched.

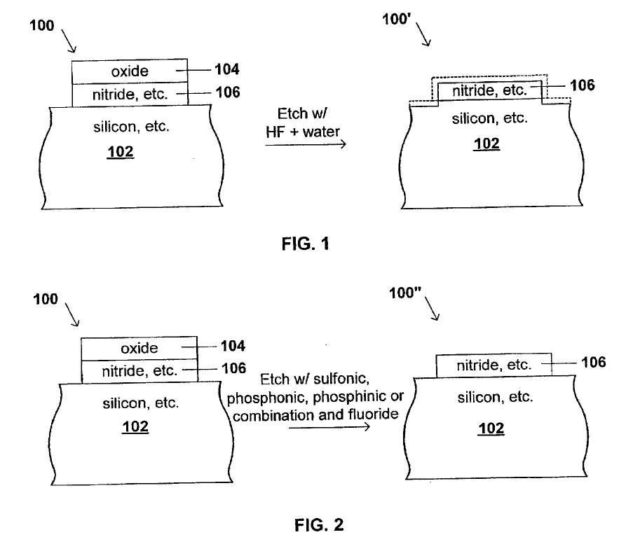

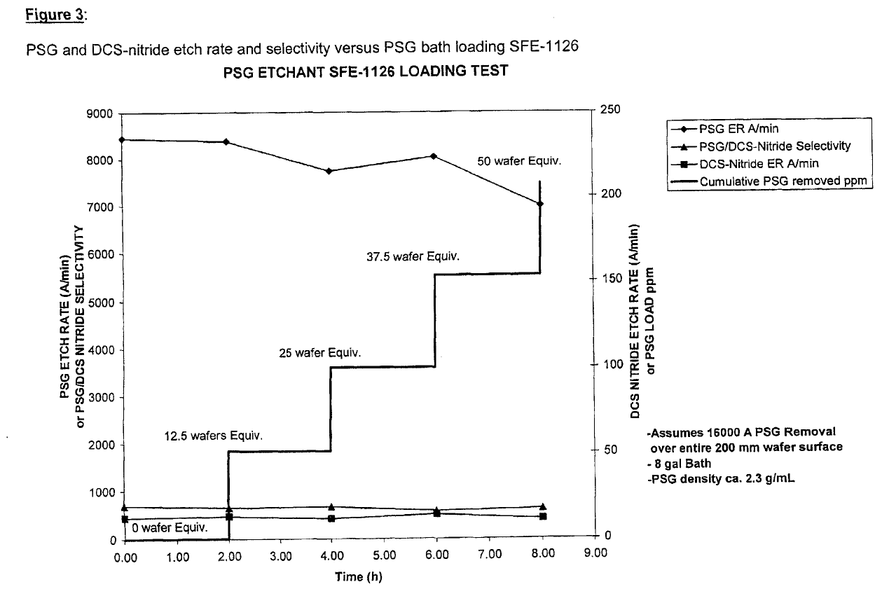

FIG. 2 is a drawing depicting the selective etching of oxide with respect to surrounding structures using an etching composition in accordance with the present invention. In FIG. 2, the structure 100 includes a substrate 102 formed of, e.g., silicon, over which is formed a layer of nitride 104. Over the layer of nitride 104 is formed a layer of oxide 106, identical to that shown in FIG. 1. If the structure 100 is subjected to an etch process using a selective wet etching composition in accordance with the present invention, including a sulfonic acid, a phosphonic acid and/or a phosphinic acid together with a fluoride, only the layer of oxide 106 is etched away, and substantially all of both the layer of nitride 104 and the substrate 102 remain and are not etched away. The etching process in FIG. 2 is quite selective, as described herein for the present invention. That is, in the product structure 100″, the etching process in accordance with the present invention selectively removes the layer of oxide 106, while leaving substantially all of the layer of nitride 104 and the substrate 102, which are not intended to be etched.

FIG. 3 provides exemplary results for an etching composition in accordance with the present invention, when it is tested for bath life with time and PSG loading. The data in FIG. 3 shows that the etching composition is effective at etching the oxide, selective for oxide as compared to nitride and other materials, and efficient in being capable of etching a large amount of oxide. In this exemplary embodiment, the etching composition comprises 77 wt. % methanesulfonic acid, 3 wt. % hydrogen fluoride and the remaining 20 wt. % water. In this exemplary embodiment, the conditions for the bath life test are; bath temperature 24° C., 400 g sample, open cup (9:7 aspect ratio vessel) with slow stirring and ventilation. Additional PSG is loaded into the etching composition every 2 hours over an 8-hour period. Each loading (2 hour increments) is calculated to be approximately equivalent to 12.5 wafers (200 mm) processed with removal of ca. 16000 Å PSG in an 8 gal. immersion bath. The PSG loading is immediately followed by etch rate tests on PSG, TiN and DCS-nitride at 24° C. @ 1 min. As shown in FIG. 3, the PSG etch rate in one exemplary etching composition slowly decreases (10-15%) over an 8-hour period but the PSG/DCS-nitride selectivity is maintained. As also shown in FIG. 3, the TiN and polysilicon etch rate remain low at less than about 3 Å/min and less than about 20 Å/min, respectively, over the entire bath loading/time test.

Thus, the present invention provides a solution to the problem of selective etching of oxide with respect to nitride, while maintaining economy and efficiency.

### Wet Etching Compositions

In accordance with one embodiment of the present invention, there is provided a wet etching composition including a sulfonic acid, a phosphinic acid, a phosphonic acid or a mixture of any two or more such acids, and a fluoride. In one embodiment, the etching composition is selective for etching silicon oxynitride, silicon dioxide and silicate glasses relative to materials such as silicon nitride, titanium nitride, high-nitrogen content silicon oxynitride, metals, silicon and silicides. In one embodiment, the silicon comprises one or more of amorphous silicon, polysilicon and monocrystalline silicon.

In one embodiment, the composition etches PSG at ambient temperature at a rate ranging from about 1500 to about 15,000 angstrom/minute (Å/min), silicon nitride at a rate ranging from about 1 to about 20 Å/min, titanium nitride at a rate ranging from about 0 to about 3 Å/min, and polysilicon at a rate ranging from about 0 to about 20 angstroms/minute. Other materials may have intermediate etch rates, depending on the substrate being etched (chemical nature, morphology, deposition method, etc.) and the exact etchant composition.

### Sulfonic Acids

In one embodiment, the etching composition comprises sulfonic acid. In one embodiment, the etching composition comprises sulfonic acid together with a phosphinic acid, a phosphonic acid or both.

In one embodiment, the sulfonic acid comprises an alkyl or aryl sulfonic acid. Alkyl sulfonic acids include, e.g., methane sulfonic acid. Aryl sulfonic acids include, e.g., benzene sulfonic acid or toluene sulfonic acid. In one embodiment, the alkyl group may be branched or unbranched and may contain from one to about 20 carbon atoms. In one embodiment, the alkyl group may be substituted or unsubstituted. In one embodiment, the aryl group may be alkyl-substituted, i.e., may be an alkylaryl group, or may be attached to the sulfonic acid moiety via an alkylene group, in which case it may be referred to as an arylalkyl group (and the molecule then would be considered an alkyl-substituted sulfonic acid). In one embodiment, the aryl group may be substituted with a heteroatom such as those defined in the following as possible substituents. In one embodiment, the aryl group may range from six to about 20 carbon atoms, and may be polynuclear.

If the alkyl or aryl sulfonic acid is substituted, the substituents may comprise halogens, oxygen, nitrogen (including nitrate, amine, etc.), sulfur (including thio, sulfonic, sulfate, sulfoxide, etc.,) or aryl, as defined above. In general, such substituents may be suitably selected, together with other atoms, to affect, adjust and/or control the activity of the sulfonic acid portion of the molecule.

In one embodiment, the sulfonic acid includes arylalkyl or alkylaryl sulfonic acids, in which the alkyl substituents may range from C₁ to about C₂₀ and in which the aryl substituents (before substitution) may be phenyl or naphthyl or higher, or mixtures of two or more of these, may be suitably used as the acid component. Arylalkyl sulfonic acids include, e.g., benzyl sulfonic acid. Alkylaryl sulfonic acids include, e.g., toluene sulfonic acid.

In one embodiment, the sulfonic acid comprises methanesulfonic acid, ethanesulfonic acid, ethane disulfonic acid, propanesulfonic acid, butanesulfonic acid, pentanesulfonic acid, hexanesulfonic acid, heptane sulfonic acid, dodecanesulfonic acid, benzenesulfonic acid, toluenesulfonic acid, 2-hydroxyethane-sulfonic acid, alkyl phenol sulfonic acids, chlorosulfonic acid, fluorosulfonic acid, bromosulfonic acid, 1-naphthol-4-sulfonic acid, 2-bromoethanesulfonic acid, 2,4,6-trichlorobenzenesulfonic acid, phenylmethanesulfonic acid, trifluoromethanesulfonic acid, perfluorobutyl sulfonic acid, cetylsulfonic acid, dodecylsulfonic acid, 2-, 3-, or 4-nitrobenzenesulfonic acid, di-nitrobenzenesulfonic acid, trinitrobenzenesulfonic acid, benzene-1,4-disulfonic acid, methyl-4-nitrobenzenesulfonic acid, methyldichlorobenzene sulfonic acid, isomers thereof, corresponding polysulfonic acids or mixtures of any two or more thereof.

The foregoing are merely exemplary sulfonic acids, and others within the scope of the general description given above may be suitably selected for use in the present invention.

The sulfonic acid is generally present in the etching composition in a concentration ranging from about 0.1 to about 95 wt. % based on the etching composition. In one embodiment, the sulfonic acid is present in the etching composition in a concentration ranging from about 1 to about 50 wt. % based on the etching composition. In one embodiment, the sulfonic acid is present in the etching composition in a concentration ranging from about 10 to about 90 wt. % based on the etching composition. In one embodiment, the sulfonic acid is present in the etching composition in a concentration ranging from about 40 to about 80 wt. % based on the etching composition. In one embodiment, the sulfonic acid is present in the etching composition in a concentration ranging from about 40 to about 50 wt. %, and in one, about 45 wt. %, based on the etching composition. In one embodiment, the sulfonic acid is present in the etching composition in a concentration ranging from about 70 to about 80 wt. %, and in one about 77 wt. %, based on the etching composition.

### Phosphonic and Phosphinic Acids

In one embodiment, the etching composition comprises a phosphonic acid, RPO₃H₂, which also may be written as RP(O)(OH)₂. Phosphonic acids may also referred to as organophosphorous acids. In one embodiment, the phosphonic acid comprises a C₁-C₁₀ branched or unbranched alkyl or C₆-C₂₄ aryl or C₁-C₁₀ branched or unbranched alkyl-substituted C₇-C₃₆ aryl phosphonic acid. In one embodiment, the phosphonic acid includes one or more of hydroxyethylidene diphosphonic acid, nitrilotrimethylene phosphonic acid, methylphosphonic acid and phenylphosphonic acid.

In one embodiment, the etching composition comprises a phosphinic acid, RHPO₃H₂, which also may be written as RHP(O)(OH)₂. In one embodiment, the phosphinic acid comprises a C₁-C₁₀ branched or unbranched alkyl or C₆-C₂₄ aryl or C₁-C₁₀ branched or unbranched alkyl-substituted C₇-C₃₆ aryl phosphinic acid.

The acid may include, for example, nitrilotrimethylene phosphonic acid, hydroxyethylidene diphosphonic acid, phenylphosphonic acid, methylphosphonic acid, phenylphosphinic acid, and similar acids based on the phosphonic, phosphinic, phosphoric, or phosphorous acids. In one embodiment, the phosphonic acid includes one or more of hydroxyethylidene diphosphinic acid, nitrilotrimethylene phosphinic acid, methylphosphinic acid, and phenylphosphinic acid.

The phosphonic or phosphinic acid is generally present in the etching composition in a concentration ranging from about 0.1 to about 95 wt. % based on the etching composition. In one embodiment, the phosphonic or phosphinic acid is present in the etching composition in a concentration ranging from about 1 to about 50 wt. % based on the etching composition. In one embodiment, the phosphonic or phosphinic acid is present in the etching composition in a concentration ranging from about 10 to about 90 wt. % based on the etching composition. In one embodiment, the phosphonic or phosphinic acid is present in the etching composition in a concentration ranging from about 40 to about 80 wt. % based on the etching composition. In one embodiment, the phosphonic or phosphinic acid is present in the etching composition in a concentration ranging from about 40 to about 50 wt. %, and in one, about 45 wt. %, based on the etching composition. In one embodiment, the phosphonic or phosphinic acid is present in the etching composition in a concentration ranging from about 70 to about 80 wt. %, and in one about 77 wt. %, based on the etching composition.

In an embodiment in which a mixture or combination of the sulfonic, phosphonic and/or phosphinic acid is used, the foregoing amounts would be applied to the total acid content, and the amount of each of the respective acids in the mixture may be at any value within the range for the total acid, with the total applying to the combination.

### Fluorides

In one embodiment, the fluoride is hydrogen fluoride, HF. In one embodiment, the fluoride is a fluoride compound such as NH₄F, BF₄, PF₆, SiF₆²⁻, HF:pyridinium, quaternary ammonium or phosphonium fluorides or bifluorides, alkyl or aryl quaternary ammonium or phosphonium fluorides and mixtures of any two or more thereof. Bifluorides of the foregoing may also be used.

In one embodiment, the etching composition comprises fluoride in a concentration from about 0.1 wt. % to about 40 wt. %, based on the etching composition. In one embodiment, the etching composition comprises fluoride in a concentration from about 1 wt. % to about 40 wt. %, based on the etching composition. In one embodiment, the etching composition comprises fluoride in a concentration from about 2 wt. % to about 30 wt. %, based on the etching composition. In one embodiment, the etching composition comprises fluoride in a concentration from about 2 wt. % to about 20 wt. %, based on the etching composition. In one embodiment, the etching composition comprises fluoride in a concentration from about 3 wt. % to about 10 wt. %, and in one embodiment, about 5 wt. %, based on the etching composition.

### Water

In one embodiment, the wet etching composition includes less than about 30 wt. % water, and in another embodiment, from about 5 wt. % to about 30 wt. % water. In one embodiment, the wet etching composition includes from about 10 to about 25 wt. % water, and in another about 15 to about 20 wt. % water, and in another about 17 wt. % water. The selectivity of the wet etching composition is better when the water content is less than about 30 wt. %.

In one embodiment, the wet etching composition is anhydrous. In one embodiment, the wet etching composition is free of any added water. In this latter embodiment, the composition may comprise a small amount of water that is present as an impurity or component of one of the materials added to form the wet etching composition.

### Non-Aqueous Solvent

In one embodiment, the composition further comprises from about 0.1 to about 60 wt. % of a solvent other than water. In one embodiment, the non-aqueous solvent comprises sulfolane. In one embodiment, the non-aqueous solvent comprises one or more of an alcohol, an alkoxyalcohol, a polyether alcohol. Examples of such alcohols and alkoxyalcohols include, for example, methanol, ethanol, propanol, butoxyethanol, and butoxyethoxyethanol. Polyether alcohols such as polyoxyalkylenes may also be used. In one embodiment, the non-aqueous solvent includes polyethers such as glyme, diglyme, triglyme, and higher alkyloxyethers. In one embodiment the non-aqueous solvent comprises a dialkylacetamide, such as dimethylacetamide. In one embodiment, the non-aqueous solvent comprises dimethylsulfone, dimethylsulfoxide, sulfolane, or a mixture of two or more thereof. Other suitable non-aqueous solvents may also be used.

### Organic Onium Fluorides and Compounds

In one embodiment, the fluoride may comprise an organic onium fluoride. In another embodiment, the etching composition may include an organic onium compound as an additive. Suitable organic onium compounds for the present invention include organic onium salts and organic onium salts such as quaternary ammonium salts, quaternary phosphonium salts, tertiary sulfonium salts, tertiary sulfoxonium salts and imidazolium salts. As used herein, disclosure of or reference to any onium salt should be understood to include the corresponding salts, such as halides, carbonates, formates, sulfates and the like. As will be understood, such salts may be prepared from the corresponding hydroxides. In the following discussion of onium compounds, the fluorides are generally used as examples; however, it should be understood that the other salts noted above may be used instead or in addition to the fluorides.

In one embodiment, the onium fluorides may generally be characterized by the formula I:

A(F)ₓ (I)

wherein A is an onium group and x is an integer equal to the valence of A. Examples of onium groups include ammonium groups, phosphonium groups, sulfonium, sulfoxonium and imidazolium groups. In one embodiment, the onium fluoride should be sufficiently soluble in a solution such as water, alcohol or other organic liquid, or mixtures thereof to permit a useful wet etch rate.

In one embodiment, the quaternary ammonium fluorides and quaternary phosphonium fluorides may be characterized by the formula II:

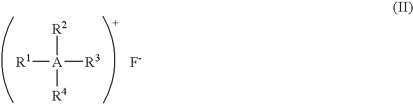

wherein A is a nitrogen or phosphorus atom, R¹, R², R³ and R⁴ are each independently alkyl groups containing from 1 to about 20, or 1 to about 10 carbon atoms, hydroxyalkyl or alkoxyalkyl groups containing from 2 to about 20, or 2 to about 10 carbon atoms, aryl groups or hydroxyaryl groups, or R¹ and R² together with A may form a heterocyclic group provided that if the heterocyclic group contains a C=A group, R³ is the second bond.

The alkyl groups R¹ to R⁴ may be linear or branched, and specific examples of alkyl groups containing from 1 to 20 carbon atoms include methyl, ethyl, propyl, butyl, pentyl, hexyl, heptyl, octyl, isooctyl, nonyl, decyl, isodecyl, dodecyl, tridecyl, isotridecyl, hexadecyl and octadecyl groups. R¹, R², R³ and R⁴ also may be hydroxyalkyl groups containing from 2 to 5 carbon atoms such as hydroxyethyl and the various isomers of hydroxypropyl, hydroxybutyl, hydroxypentyl, etc. In one embodiment, R¹, R², R³ and R⁴ are independently alkyl and/or hydroxyalkyl groups containing 1 to about 4 or 5 carbon atoms. Specific examples of alkoxyalkyl groups include ethoxyethyl, butoxymethyl, butoxybutyl, etc. Examples of various aryl and hydroxyaryl groups include phenyl, benzyl, and equivalent groups wherein benzene rings have been substituted with one or more hydroxy groups.

In one embodiment, the quaternary onium salts which can be employed in accordance with the present invention are characterized by the Formula III:

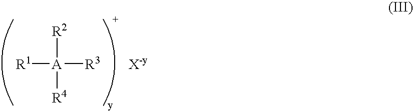

wherein A, R¹, R², R³ and R⁴ are as defined in Formula II, X⁻ is an anion of an acid, e.g., fluoride, and y is a number equal to the valence of X. Examples of anions of acids include bicarbonates, halides, nitrates, formates, acetates, sulfates, carbonates, phosphates, etc.

In one embodiment, the quaternary ammonium compounds (fluorides and salts) which can be treated in accordance with the process of the present invention may be represented by Formula IV:

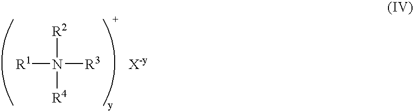

wherein R¹, R², R³, R⁴, and y are as defined in Formula II, and X⁻ is a fluoride anion or an anion of an acid. In one embodiment, R¹-R⁴ are alkyl and/or hydroxyalkyl groups containing from 1 to about 4 or 5 carbon atoms. Specific examples of ammonium fluorides include tetramethylammonium fluoride (TMAF), tetraethylammonium fluoride (TEAF), tetrapropylammonium fluoride, tetrabutylammonium fluoride, tetra-n-octylammonium fluoride, methyltriethylammonium fluoride, diethyldimethylammonium fluoride, methyltripropylammonium fluoride, methyltributylammonium fluoride, cetyltrimethylammonium fluoride, trimethylhydroxyethylammonium fluoride, trimethylmethoxyethylammonium fluoride, dimethyldihydroxyethylammonium fluoride, methyltrihydroxyethylammonium fluoride, phenyltrimethylammonium fluoride, phenyltriethylammonium fluoride, benzyltrimethylammonium fluoride, benzyltriethylammonium fluoride, dimethylpyrrolidinium fluoride, dimethylpiperidinium fluoride, diisopropylimidazolinium fluoride, N-alkylpyridinium fluoride, etc. In one embodiment, the quaternary ammonium fluorides used in accordance with this invention are TMAF and TEAF. The quaternary ammonium salts represented by Formula IV may be similar to the above quaternary ammonium fluorides except that the fluoride anion is replaced by, for example, a sulfate anion, a chloride anion, a carbonate anion, a formate anion, a phosphate ion, etc. For example, the salt may be tetramethylammonium chloride, tetramethylammonium sulfate (y=2), tetramethylammonium bromide, 1-methyl-2-butyl imidazolium hexafluorophosphate, n-butyl pyridinium hexafluorophosphate, etc.

Examples of quaternary phosphonium salts representative of Formula III wherein A=P which can be employed in accordance with the present invention include tetramethylphosphonium fluoride, tetraethylphosphonium fluoride, tetrapropylphosphonium fluoride, tetrabutylphosphonium fluoride, trimethylhydroxyethylphosphonium fluoride, dimethyldihydroxyethylphosphonium fluoride, methyltrihydroxyethylphosphonium fluoride, phenyltrimethylphosphonium fluoride, phenyltriethylphosphonium fluoride and benzyltrimethylphosphonium fluoride, etc, and the corresponding halides, sulfates, carbonates, phosphates, etc.

In another embodiment, the tertiary sulfonium fluorides and salts which can be employed in accordance with the present invention may be represented by the formula V:

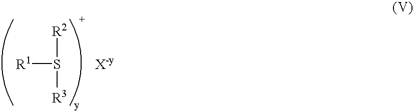

wherein R¹, R² and R³, X⁻ and y are as defined in Formula III.

Examples of the tertiary sulfonium compounds represented by Formula V include trimethylsulfonium fluoride, triethylsufonium fluoride, tripropylsulfonium fluoride, etc, and the corresponding salts such as the halides, sulfates, nitrates, carbonates, etc.

In another embodiment, the tertiary sulfoxonium fluorides and salts which can be employed in accordance with the present invention may be represented by the formula VI:

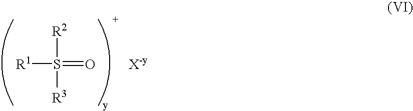

wherein R¹, R² and R³, X⁻ and y are as defined in Formula III.

Examples of the tertiary sulfoxonium compounds represented by Formula V include trimethylsulfoxonium fluoride, triethylsulfoxonium fluoride, tripropylsulfoxonium fluoride, etc, and the corresponding salts such as the halides, sulfates, nitrates, carbonates, etc.

In another embodiment, the imidazolium fluorides and salts which can be employed in accordance with the present invention may be represented by the formula VIII:

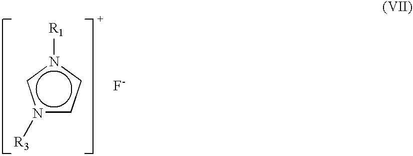

wherein R¹ and R³ are as defined in Formula II.

Onium fluorides are commercially available. Additionally, onium fluorides can be prepared from the corresponding onium salts such as the corresponding onium halides, carbonates, formates, sulfates and the like. Various methods of preparation are described in U.S. Pat. Nos. 4,917,781 (Sharifian et al) and 5,286,354 (Bard et al) which are hereby incorporated by reference. There is no particular limit as to how the onium fluoride is obtained or prepared.

In one embodiment, the organic onium fluoride comprises one or more of tetramethylammonium fluoride, tetraethylammonium fluoride, tetrapropylammonium fluoride, tetrabutylammonium fluoride, methyltriphenylammonium fluoride, phenyltrimethylammonium fluoride, benzyltrimethylammonium fluoride, methyltriethanolammonium fluoride, tetrabutylphosphonium fluoride, methyltriphenylphosphonium fluoride, trihexyltetradecylphosphonium fluoride, tributyltetradecylphosphonium fluoride, [(CH₃)₃NCH₂CH(OH)CH₂N(CH₃)₃]²+[F⁻]₂, 1-butyl-3-methylimidazolium fluoride, trimethylsulfonium fluoride, trimethylsulfoxonium fluoride, trimethyl (2,3-dihydroxypropyl) ammonium fluoride, [(C₆H₅)CH₂N(CH₃)₂CH₂CH(OH)CH₂N(CH₃)₂CH₂CH(OH)CH₂N(CH₃)₂CH₂—CH(OH)CH₂N(CH₃)₂CH₂(C₆H₅)]⁴⁺[F⁻]₄, and [(CH₃)₃NCH₂CH(OH)CH₂OH]⁺[F⁻], and hexamethonium difluoride. In one embodiment, the onium fluoride is benzyltrimethylammonium fluoride.

The concentration of the onium fluoride in the compositions of the present invention may range up to about 20 wt % of the wet etching composition. Appropriate dilutions can be determined by those of skill in the art, based on the concentration supplied and the concentration desired to be employed in the wet etching composition.

In one embodiment, the onium fluoride concentration is in a range from about 0.5 wt % to about 15 wt %, and in another embodiment, the onium fluoride concentration is in a range from about 2 wt % to about 10 wt %, and in another embodiment, the onium fluoride concentration is in a range from about 3 wt % to about 8 wt %, and in one embodiment, the onium fluoride concentration is about 4 wt %, all concentrations based on the total weight of the wet etching composition.

### Auxiliary Acids

In addition to the sulfonic acid, phosphonic and/or phosphinic acid, in one embodiment, an auxiliary acid may be added to the etching composition of the present invention. Any suitable acid may be used. In one embodiment, the acid is an organic acid. In another embodiment, the acid is an inorganic acid. The acid may include a mixture or combination of two or more these acids.

In one embodiment, the acid is other than a bi- or higher dentate chelating agent. In one embodiment, the acid is other than ethylene diamine tetraacetic acid (EDTA) or similar chelating agents based on ethylene diamine, diethylene triamine and higher multi-amine multi-acetic acid compounds.

Typical examples of the organic acids may include formic acid, acetic acid, propionic acid, butyric acid, isobutyric acid, valeric acid, ethylmethylacetic acid, trimethylacetic acid, glycolic acid, butanetetracarboxylic acid, oxalic acid, succinic acid, malonic acid, citric acid, tartaric acid, malic acid, gallic acid, behenic acid, arachidic acid, stearic acid, palmitic acid, lauric acid, salicylic acid, benzoic acid, and 3,5-dihydroxybenzoic acid, or the like. Mixtures of two or more of these acids may be used.

Inorganic auxiliary acids may include phosphoric or phosphorous acids and partial alkyl esters thereof.

Exemplary inorganic and organic acids that may be included in the compositions include hydrochloric acid, nitric acid, sulfuric acid, sulfurous acid, hydrobromic acid, perchloric acid, fluoboric acid, phytic acid, nitrilotriacetic acid, maleic acid, phthalic acid, lactic acid, ascorbic acid, gallic acid, sulfoacetic acid, 2-sulfobenzoic acid, sulfanilic acid, phenylacetic acid, betaine, crotonic acid, levulinic acid, pyruvic acid, trifluoroacetic acid, glycine, cyclohexanecarboxylic acid, cyclohexanedicarboxylic acid, cyclopentanedicarboxylic acid, adipic acid, and mixtures or combinations of two or more thereof.

In one embodiment, the auxiliary acid may include other, relatively weak, sulfonic acids such as, for example, N-(2-hydroxyethyl)-N′-(2-ethane sulfonic acid) (HEPES), 3-(N-morpholino) propane sulfonic acid (MOPS) and piperazine-N,N′-bis(2-ethane sulfonic acid) (PIPES).

The concentration of the auxiliary acid in the compositions of the present invention may range from 0.1 wt % to about 10 wt % of the etching composition. Appropriate dilutions can be determined by those of skill in the art, based on the concentration supplied and the concentration desired to be employed in the wet etching composition. In one embodiment, the auxiliary acid concentration is in a range from about 0.2 wt % to about 5 wt %, and in another embodiment, the auxiliary acid concentration is in a range from about 0.5 wt % to about 4 wt %, and in another embodiment, the auxiliary acid concentration is in a range from about 1 wt % to about 3 wt %, and in one embodiment, the auxiliary acid concentration is about 2 wt %, all concentrations based on the total weight of the wet etching composition, and are in addition to the sulfonic acid component. The concentration of the auxiliary acid may be adjusted based on factors such as the strength (or pKₐ), solubility and complexing power of the acid.

In one embodiment, the composition is substantially free of added hydroxylamine, nitrate, persulfate or any combination of two or more thereof.

Wet etching composition pH

The pH of the wet etching composition in accordance with the present invention may be a pH in the range from about −1 to about 3, and in one embodiment, a pH in the range from about 0 to about 2, and in another embodiment, a pH of about 1, and in one embodiment, the pH is about 1.5. In one embodiment, the composition has a pH less than about 2. The pH can be adjusted as needed by manipulating sulfonic acid and/or auxiliary acid selection, acid concentration, selection of fluoride and fluoride concentration and by addition of suitable buffers, if required, as will be understood by those of skill in the art. As will be recognized, reference to “pH” in the wet etching compositions applies to the hydrogen ion concentration as if these compositions had a much higher water content in which the acid is capable of fully dissociating. In order to measure the pH by, e.g., a pH meter, it may be necessary to dilute the wet etching composition by a factor of 10 or 100. In one embodiment, the “pH” referred to herein relates to the pH of the same acid dissolved in water at the same concentration as in the present invention. Thus, it would be assumed that the acid is fully dissociated in the wet etching compositions of the present invention, for purposes of referring to the pH of the composition.

### Photoresists

The present invention may be used with a variety of different photoresist materials, including but not limited to, Novolacs, methacrylates, acrylates, styrenes, sulfones and isoprenes. Exemplary photoresist materials include positive photoresists, such as those that include a Novolac resin, a diazonaphthaquinone, and a solvent (e.g., n-butyl alcohol or xylene), and negative photoresist materials, such as those that include a cyclized synthetic rubber resin, bis-arylazide, and an aromatic solvent. In one embodiment, suitable photoresists include negative photoresists, such as for example, MacDermid Aquamer CFI or Ml, du Pont Riston 9000, or du Pont Riston 4700, or Shipley UV5 and TOK DP019. Positive photoresists include AZ3312, AZ3330, Shipley 1.2 L and Shipley 1.8M. Negative photoresists include nLOF 2020 and SU8. Examples of additional suitable resists include the AZ 5218, AZ 1370, AZ 1375, or AZ P4400, from Hoechst Celanese; CAMP 6, from OCG; DX 46, from Hoechst Celanese; XP 8843, from Shipley; and JSR/NFR-0,6-D2, from JSR, Japan. Suitable photoresists are described in U.S. Pat. Nos. 4,692,398; 4,835,086; 4,863,827 and 4,892,801. Suitable photoresists may be purchased commercially as AZ4620, from Clariant Corporation of Somerville, N.J. Other suitable photoresists include solutions of polymethylmethacrylate (PMMA), such as a liquid photoresist available as 496 k PMMA, from OLIN HUNT/OCG, West Paterson, N.J. 07424, comprising polymethylmethacrylate with molecular weight of 496,000 dissolved in chlorobenzene (9 wt %); (meth)acrylic copolymers such as P(MMA-MAA) (poly methyl methacrylate-methacrylic acid); PMMA/P(MMA-MAA) polymethylmethacrylate/(poly methyl methacrylate-methacrylic acid). Any suitable photoresist, whether existing or yet-to-be-developed, is contemplated, regardless of whether such comprises a positive or negative type photoresist.

### Methods of Selective Oxide Etching

In accordance with another embodiment of the present invention, there is provided a process of selectively etching oxide relative to nitride, metal, silicon or silicide, comprising:

providing a substrate comprising oxide and one or more of nitride, metal, silicon or silicide in which the oxide is to be etched;

applying to the substrate for a time sufficient to remove a desired quantity of oxide from the substrate an etching composition comprising:
a sulfonic acid and
a fluoride; and

removing the etching composition,

wherein the oxide is removed selective to the one or more of nitride, metal, silicon or silicide.

In one embodiment, the methods used in carrying out the process of the present invention are substantially similar or the same as wet etching methods known in the art, except for the use of the wet etching composition in accordance with the present invention. Thus, in one embodiment, all that is needed to carry out the method of the present invention is to substitute the wet etching composition of the present invention into a conventional wet etching process.

In one embodiment, the etching composition is applied at a temperature in the range from about 15° C. to about 60° C. Additional details on temperatures are given below.

In one embodiment, the etching composition is removed by washing with a rinse composition comprising water and/or a solvent.

In one embodiment, the oxide is removed at a rate greater than about 1500 angstroms/minute at a temperature of about 20° C. Additional details on etch rates are given below.

The following describes exemplary conditions for carrying out embodiments of this method. Additional details and modifications can be determined by those of skill in the art.

### Processing Time

The time needed for carrying out a method of selectively wet etching a silicon oxide in accordance with an embodiment of the present invention may be suitably selected based on factors known to those of skill in the art, including the identity of the silicon oxide to be etched, the thickness of the silicon oxide to be etched, the method by which the silicon oxide was deposited (which may affect properties such as hardness, porosity and texture of the silicon oxide), concentrations of sulfonic acid, fluoride, other ingredients, temperature and rate of stirring or mixing of the wet etching composition, volume of the wet etching composition relative to the quantity and/or size of wafers or parts to be treated, and similar factors known to affect etch rates in conventional silicon oxide etching methods. In one embodiment, the time of exposure of the wet etching composition to the silicon oxide ranges from about 1 minute to about 60 minutes, and in another embodiment, the time ranges from about 2 minutes to about 40 minutes, and in another embodiment the time ranges from about 5 minutes to about 20 minutes, and in yet another embodiment, the time ranges from about 7 to about 15 minutes. In one embodiment, the time ranges from about 30 seconds to about 4 minutes.

### Processing Temperatures

The bath or composition temperature for carrying out a method of selectively wet etching a silicon oxide in accordance with an embodiment of the present invention may be suitably selected based on factors known to those of skill in the art, including the identity of the silicon oxide to be etched, the thickness of the silicon oxide to be etched, the method by which the silicon oxide was deposited (which may affect properties such as hardness, porosity and texture of the silicon oxide), concentrations of sulfonic acid, fluoride, other ingredients, rate of stirring or mixing of the wet etching composition, volume of the wet etching composition relative to the quantity and/or size of wafers or parts to be treated, the time allotted for the etching, and similar factors known to affect etch rates in conventional silicon oxide etching methods. In one embodiment, the bath or composition temperature of the wet etching composition for wet etching the silicon oxide ranges from about 15° C. to about 60° C., and in another embodiment, the bath or composition temperature ranges from about 20° C. to about 45° C., and in another embodiment the bath or composition temperature ranges from about 25° C. to about 40° C., and in yet another embodiment, the bath or composition temperature ranges from about 25° C. to about 35° C.

### Etch Rates

Etch rates may be suitably selected by those of skill in the art based on factors known, such as time, temperature, identity of the sulfonic acid, of the fluoride and of the silicon oxide to be etched, and on the selectivity attained for the specific materials surrounding the silicon oxide to be etched, and other factors known or easily determined by persons of skill in the art.

As noted, the intent of the present invention is to etch oxides, e.g., silicon oxides such as those defined above, selectively with respect to materials which commonly surround or exist in adjacent or nearby structures, and which could be etched by the same etching composition in the absence of such selectivity. Thus, the etching composition should exhibit a high etch rate of such oxides, while exhibiting a comparatively low etch rate of such materials that are not intended to be etched, such as nitrides, high-nitrogen content silicon oxynitride, metals, silicon, silicides and photoresist materials.

In one embodiment, the etching composition has an etching rate of silicon nitride of less than about 20 angstroms/minute. In one embodiment, the etching composition has an etching rate of silicon nitride of less than about 10 angstroms/minute. In one embodiment, the etching composition has an etching rate of silicon nitride of less than about 5 angstroms/minute.

In one embodiment, the etching composition has an etching rate of high nitrogen content silicon oxynitride of less than about 15 angstroms/minute. In one embodiment, the etching composition has an etching rate of high nitrogen content silicon oxynitride of less than about 10 angstroms/minute. In one embodiment, the etching composition has an etching rate of high nitrogen content silicon oxynitride of less than about 5 angstroms/minute. High nitrogen content silicon oxynitride is defined to contain less than about 5 atomic weight percent oxygen. High oxygen content silicon oxynitride is defined to contain less than about 5 atomic weight percent nitrogen.

In one embodiment, the etching composition has an etching rate of titanium nitride of less than about 3 angstroms/minute.

In one embodiment, the etching composition has an etching rate of polysilicon of less than about 20 angstroms/minute. In one embodiment, the etching composition has an etching rate of polysilicon of less than about 10 angstroms/minute. In one embodiment, the etching composition has an etching rate of polysilicon of less than about 5 angstroms/minute.

In one embodiment, the etching composition has an etching rate of 6% phosphorus-doped oxide (PSG) from about 1500 angstrom/min to about 15,000 angstrom/min. In one embodiment, the etching composition has an etching rate of boron-phosphorus-doped oxide (BPSG) from about 1500 angstrom/min. to about 15,000 angstrom/min. In one embodiment, the etching composition has an etching rate of 6% boron-doped oxide (BSG) from about 1500 angstrom/min. to about 15,000 angstrom/min. In one embodiment, the etching composition has an etching rate of high oxygen content silicon oxynitride from about 1500 angstrom/min. to about 15,000 angstrom/min. Silicon oxynitride is generally referred to as SiON, and includes SiOₓN_{y} and SiOₓN_{y}H_{z}, in which x, y and z are appropriate stoichiometric values for a substantially balanced compound. As noted above, high oxygen content silicon oxynitride contains less than about 5 atomic weight percent nitrogen. In one embodiment, the etching composition has an etching rate of disilane-based CVD deposited silicon dioxide from about 1500 angstrom/min. to about 15,000 angstrom/min. In one embodiment, the etching composition has an etching rate of thermally formed silicon dioxide from about 1500 angstrom/min. to about 15,000 angstrom/min. In one embodiment, the etching composition has an etching rate of TEOS-source spin-on silicon dioxide from about 1500 angstrom/min. to about 15,000 angstrom/min. In one embodiment, the etching composition has an etching rate of TEOS-source CVD deposited silicon dioxide from about 1500 angstrom/min. to about 15,000 angstrom/min.

As will be recognized, the etch rates for all of the relevant materials may vary to some extent, based on factors such as differences in morphology or material, the method by which the material was formed or deposited, whether the material was densified, whether the material was damaged or otherwise treated to increase its etchability, and other relevant treatments that may have an effect on the actual, observed etch rate. In the present invention, it is the relative etch rates, and selectivities, that are of primary importance.

### Selectivity

In one embodiment, the etching composition has a selectivity for etching CVD oxide, thermal oxide, TEOS oxide, PSG, BPSG, BSG, high oxygen content silicon oxynitride and combinations of any two or more thereof relative to silicon nitride, titanium nitride, high nitrogen content silicon oxynitride, metal, polysilicon, monocrystalline silicon and metal silicides ranging from about 15,000:1 to about 200:1. In one embodiment, the etching composition has a selectivity for etching PSG relative to CVD dichloro-silane silicon nitride ranging from about 200:1 to about 800:1, at about 23° C. In one embodiment, the etching composition has a selectivity for etching PSG relative to CVD dichloro-silane silicon nitride ranging from about 250:1 to about 700:1, at about 23° C. In one embodiment, the etching composition has a selectivity for etching PSG relative to CVD dichloro-silane silicon nitride ranging from about 300:1 to about 600:1, at about 23° C. These relative etch rates and selectivities relate to these specific materials, and corresponding selectivities may be observed for other materials or materials applied or deposited by other methods and/or having other morphologies.

In one embodiment, the composition has a selectivity for etching HPCVD oxide, APCVD oxide, thermal oxide, BPTEOS oxide, TEOS oxide, PSG, BPSG, BSG, high oxygen content silicon oxynitride, SiOC and combinations of any two or more thereof relative to one or more of silicon nitride, high nitrogen content silicon oxynitride, titanium nitride, metal, polysilicon, monocrystalline silicon and metal suicides ranging from about 15, 000:1 to about 200:1.

### EXEMPLARY EXPERIMENTAL PROCEDURE

The following is an exemplary process for carrying out an embodiment of the present invention, and is provided for exemplary, non-limiting purposes. PSG Project Wafers

10000-15000 Å BPSG on silicon

200-300 Å TiN on 1000 Å SiO₂ on silicon

200-300 Å Polysilicon on 1000 Å SiO₂ on silicon

10000-13000 Å PSG on silicon

1000-1500 Å HCD-nitride on silicon

1000-1500 Å DCS-nitride on silicon

In one embodiment, operating temperature for the PSG etchant chemistries is 25° C. The DCS, HCD nitrides, PSG, TiN, SOD (spin-on-dielectric; e.g., SOG) and Polysilicon wafers are cleaved into 1″×1″ square pieces. The pieces are submerged into the etchant solutions at temperatures of 22-26° C. The wafer pieces are processed for 1 minute after which they are rinsed with DI water and blown dry with nitrogen. The film thicknesses before and after processing are determined by reflectometry for PSG and DCS-nitride using a NANOSPEC 210 and by resistance for TiN using a Tencor RS35c. The films are also examined by optical microscopy to assess uniformity of etch.

The conditions for the bath life test are: bath temperature of 24° C., 400 g sample, open cup (9:7 aspect ratio vessel) with slow stirring and ventilation. PSG loading of the bath life sample is accomplished by processing wafer pieces with known surface area in 400 g of etchant to remove about 8500 Å of PSG (1 min process) every 2 hours for 8 hours total. After each loading, etch tests on PSG, TiN, Polysilicon, and DCS nitride are performed. The PSG loading factor in FIG. 1 in ppm (using a PSG density of 2.3 g/cm³) represents the cumulative amount of PSG etched. Assuming 16000 Å PSG is removed over the entire surface area of a 200 mm wafer in an 8 gallon immersion bath, each 2 hours in the exemplary bath loading test (in ppm of PSG removed) is equivalent to 12.5 (200 mm) wafers processed.

### Results:

A comparison of three PSG etchant formulations is given in Table 1. The results for PSG DCS-nitride, polysilicon, and TiN etch rate for SFE-±126 versus bath age and loading are presented in Table 2. PSG, DCS-nitride, polysilicon, and TiN etch rate versus temperature is provided for SFE-1126 in Table 3.

TABLE 1
Comparison of SFE-1044, SFE-1069 and SFE-1126

| | T (° C.)/ | | | HCD- | | | |
|---|---|---|---|---|---|---|---|
| | Time | PSG | DCS-Nitride | Nitride | TiN | Poly Si | PSG/DCS- |
| Sample | (min.) | (Å/min) | (Å/min) | (Å/min) | (Å/min) | (Å/min) | Nitride |
| SFE-1044 | 23/1 | 8279 | 14.5 | 57 | <0.1 | 8.3 | 571 |
| SFE-1069 | 23/1 | 14394 | 18 | 67.5 | <0.1 | 8.3 | 800 |
| SFE-1126 | 23/1 | 7586 | 11 | 43 | <0.1 | 11 | 690 |

SFE-1044 Composition: 33%, Sulfolane, 45% Methanesulfonic Acid, 5% HF, 17% Water
SFE-1069 Composition: 80% Methanesulfonic Acid, 5% HF, 15% Water
SFE-1126 Composition: 77% Methanesulfonic Acid, 3% HF, 20% Water

TABLE 2
Processed in SFE-1126 at 24° C. @ 1 min

| | PSG | DCS-Nitride | TiN | Polysilicon | PSG/DCS- | PSG Loading |
|---|---|---|---|---|---|---|
| Sample | (Å/min) | (Å/min) | (Å/min) | (Å/min) | Nitride | ppm* |
| Initial Pour = 0 hrs | 8446 | 12.3 | 0.23 | 7 | 687 | 0 |
| Time = 2 hrs | 8383 | 13.0 | 0.06 | 14.5 | 645 | 51 |
| Time = 4 hrs | 7744 | 11.7 | 0 | 14 | 662 | 100 |
| Time = 6 hrs | 8045 | 14.0 | 0.54 | 10 | 575 | 154 |
| Time = 8 hrs | 6991 | 11.3 | 0.77 | 11.7 | 619 | 207 |

*assumes PSG density of 2.3 g/cm³

TABLE 3
SFE-1126 etch rates versus T(° C.)

| | | DCS-Nitride | TiN | Poly Si | PSG/DCS- |
|---|---|---|---|---|---|
| T (° C.) | PSG (Å/min) | (Å/min) | (Å/min) | (Å/min) | Nitride |
| 19.5 | 6202 | 11 | <0.1 | 0.3 | 564 |
| 21 | 7040 | 13.3 | <0.1 | 5.5 | 529 |
| 24 | 7586 | 12.3 | <0.1 | 11 | 617 |
| 26 | 8185 | 13.3 | <0.1 | 6.5 | 615 |

### DISCUSSION OF EXAMPLES

The primary focus of these examples is on selectively etching PSG relative to DCS-nitride, TiN and Polysilicon (Table 1) and to a bath life loading and time study monitoring etch rates on PSG, DCS-nitride, TiN and polysilicon for one of these formulations, namely, SFE-1126 (Table 2). A graph of PSG, DCS-nitride, TiN and Polysilicon etch rate and selectivity versus bath loading and age for SFE-1126 is provided in FIG. 1. Etch rate change with temperature for SFE-1126 is shown in Table 3.

Three different PSG etchants are described with PSG etch rates ranging from 7000-14000 Å/min and selectivities to DCS-nitride of 500-800:1. All etchants have low etch rates on TiN and polysilicon. In general, PSG etch rate can be varied in the range of 4000-15000 Å/min with selectivity to DCS-nitride of 300-800 with slight modifications in etch chemistry between SFE-1044, 1069 and 1126.

In one embodiment, SFE-1126 is well suited for single wafer processing, where a 1-2 min process per wafer is desirable. The SFE-1126 etch rate varies by only 1145 Å/min over a 5° C. range (19-26° C.). This corresponds to <300 Å/min per degree C. for PSG or <4% etch rate change at 24° C.±0.5° C. SFE-1126 is designed for operation at or below 25° C. to obtain the best bath life and etch characteristics (i.e. selectivity).

Throughout the foregoing specification and the following claims, the numerical limits of the ranges and ratios, including concentrations, pH, wavelengths and other ranges, may be combined. That is, for example, where ranges of 1 to 10 and 2 to 5 are disclosed, although not specifically stated, this disclosure should be understood to also include the range from 2 to 10 and from 1 to 5, as well as intervening integral values as range limits.

While the invention has been explained in relation to certain of its exemplary embodiments, it is to be understood that various modifications thereof will become apparent to those skilled in the art upon reading the specification. Therefore, it is to be understood that the invention disclosed herein is intended to cover such modifications as fall within the scope of the appended claims.

1-39. (canceled)

40. A selective wet etching composition, comprising:
from about 45 wt. % to about 80 wt. % of a sulfonic acid;
from about 0.1 wt. % to about 40 wt. % of a fluoride; and
less than about 30 wt. % of water.

41. The etching composition of claim 40 wherein the sulfonic acid comprises a substituted or unsubstituted alkyl or aryl sulfonic acid.

42. The etching composition of claim 41 wherein the sulfonic acid comprises methanesulfonic acid, ethanesulfonic acid, ethane disulfonic acid, propanesulfonic acid, butanesulfonic acid, pentanesulfonic acid, hexanesulfonic acid, heptane sulfonic acid, dodecanesulfonic acid, benzenesulfonic acid, toluenesulfonic acid, 2-hydroxyethane-sulfonic acid, alkyl phenol sulfonic acids, chlorosulfonic acid, fluorosulfonic acid, bromosulfonic acid, 1-naphthol-4-sulfonic acid, 2-bromoethanesulfonic acid, 2,4,6-trichlorobenzenesulfonic acid, phenylmethanesulfonic acid, trifluoromethanesulfonic acid, cetylsulfonic acid, dodecylsulfonic acid, 2-, 3-, or 4-nitrobenzenesulfonic acid, di-nitrobenzenesulfonic acid, trinitrobenzenesulfonic acid, benzene-1,4-disulfonic acid, methyl-4-nitrobenzenesulfonic acid, methyldichlorobenzene sulfonic acid, isomers thereof, corresponding polysulfonic acids or mixtures of any two or more thereof.

43. The etching composition of claim 40 wherein the source of fluoride comprises HF, NH₄F, BF₄, PF₆, SiF₆²⁻, HF:pyridinium, quaternary ammonium or phosphonium fluoride or bifluoride, alkyl or aryl quaternary ammonium or phosphonium fluorides and mixtures of any two or more thereof.

44. The etching composition of claim 40 further comprising an organic solvent.

45. The etching composition of claim 44 wherein the organic solvent comprises sulfolane or one or more of an alcohol, an alkoxyalcohol or a polyether alcohol.

46. The etching composition of claim 40 wherein the composition has a pH less than about 2.

47. The etching composition of claim 40 wherein the composition is substantially free of added hydroxylamine, nitrate, persulfate or any combination of two or more thereof.

48. The etching composition of claim 40 wherein the etching composition is selective for etching high oxygen content silicon oxynitride, silicon dioxide and silicate glasses over silicon nitride, high nitrogen content silicon oxynitride, titanium nitride and silicon.

49. The etching composition of claim 48 wherein the silicon comprises one or more of amorphous silicon, polysilicon and monocrystalline silicon.

50. The etching composition of claim 40 wherein the composition has a selectivity for etching HPCVD oxide, APCVD oxide, thermal oxide, BPTEOS oxide, TEOS oxide, PSG, BPSG, BSG, high oxygen content silicon oxynitride, SiOC and combinations of any two or more thereof relative to one or more of silicon nitride, high nitrogen content silicon oxynitride, titanium nitride, metal, polysilicon, monocrystalline silicon and metal silicides ranging from about 15,000:1 to about 200:1.

51. The etching composition of claim 40 wherein the composition has a selectivity for etching PSG relative to CVD dichloro-silane silicon nitride ranging from about 200:1 to about 800:1, at about 23° C.

52. The etching composition of claim 40 wherein said etching composition is characterized by an etching rate of 6% phosphorus-doped oxide (PSG) in a range from about 2000 angstroms/minute to about 15,000 angstroms/minute.

53. The etching composition of claim 40 wherein the composition etches PSG at ambient temperature at a rate ranging from about 1500 to about 15,000 Å/min, silicon nitride at a rate ranging from about 1 to about 20 Å/min, titanium nitride at a rate ranging from about 0 to about 3 Å/min, and polysilicon at a rate ranging from about 1 to about 20 angstroms/minute.

54. A process of selectively etching oxide relative to nitride, metal, silicon or silicide, comprising:
providing a substrate comprising oxide and one or more of a nitride, a high-nitrogen content silicon oxynitride, a metal, silicon or a silicide in which the oxide is to be etched;
applying to the substrate for a time sufficient to remove a desired quantity of oxide from the substrate an etching composition comprising:
from about 45 wt. % to about 80 wt. % of a sulfonic acid;
from about 0.1 wt. % to about 40 wt. % of a fluoride; and
less than about 30 wt. % of water; and
removing the etching composition;
wherein the oxide is removed selective to the one or more of nitride, high-nitrogen content silicon oxynitride, metal, silicon or silicide.

55. The process of claim 54 wherein the etching composition is applied at a temperature in the range from about 15° C. to about 60° C.

56. The process of claim 54 wherein the etching composition is removed by washing with a rinse composition comprising water and/or a solvent.

57. The process of claim 54 wherein the oxide is removed at a rate greater than about 1500 angstroms/minute at a temperature of about 20° C.

58. The process of claim 54 wherein the etching composition is characterized by an etching rate of 6% phosphorus-doped oxide (PSG) in a range from about 2000 angstroms/minute to about 15,000 angstroms/minute.

59. The process of claim 54 wherein the composition has a selectivity for etching HPCVD oxide, APCVD oxide, thermal oxide, BPTEOS oxide, TEOS oxide, PSG, BPSG, BSG, high oxygen content silicon oxynitride, SiOC and combinations of any two or more thereof relative to one or more of silicon nitride, high nitrogen content silicon oxynitride, titanium nitride, metal, polysilicon, monocrystalline silicon and metal silicides ranging from about 15,000:1 to about 200:1.

60. The process of claim 54 wherein the composition has a selectivity for etching PSG relative to CVD dichloro-silane silicon nitride ranging from about 200:1 to about 800:1, at about 23° C.

61. The process of claim 54 wherein the composition etches PSG at ambient temperature at a rate ranging from about 1500 to about 15,000 Å/min, silicon nitride at a rate ranging from about 1 to about 20 Å/min, titanium nitride at a rate ranging from about 0 to about 3 Å/min, and polysilicon at a rate ranging from about 1 to about 20 angstroms/minute.

62. The process of claim 54 wherein the sulfonic acid comprises a substituted or unsubstituted alkyl or aryl sulfonic acid.

63. The process of claim 62 wherein the sulfonic acid comprises methanesulfonic acid, ethanesulfonic acid, ethane disulfonic acid, propanesulfonic acid, butanesulfonic acid, pentanesulfonic acid, hexanesulfonic acid, heptane sulfonic acid, dodecanesulfonic acid, benzenesulfonic acid, toluenesulfonic acid, 2-hydroxyethane-sulfonic acid, alkyl phenol sulfonic acids, chlorosulfonic acid, fluorosulfonic acid, bromosulfonic acid, 1-naphthol-4-sulfonic acid, 2-bromoethanesulfonic acid, 2,4,6-trichlorobenzenesulfonic acid, phenylmethanesulfonic acid, trifluoromethanesulfonic acid, cetylsulfonic acid, dodecylsulfonic acid, 2-, 3-, or 4-nitrobenzenesulfonic acid, di-nitrobenzenesulfonic acid, trinitrobenzenesulfonic acid, benzene-1,4-disulfonic acid, methyl-4-nitrobenzenesulfonic acid, methyldichlorobenzene sulfonic acid, isomers thereof, corresponding polysulfonic acids or mixtures of any two or more thereof.

64. The process of claim 54 wherein the source of fluoride comprises HF, NH₄F, BF₄, PF₆, SiF₆²⁻, HF:pyridinium, quaternary ammonium or phosphonium fluoride, alkyl or aryl quaternary ammonium or phosphonium fluorides, or a bifluoride of any of the foregoing and mixtures of any two or more thereof.

65. The process of claim 54 wherein the composition further comprises an organic solvent.

66. The process of claim 65 wherein the organic solvent comprises sulfolane or one or more of an alcohol, an alkoxyalcohol or a polyether alcohol.

67. The process of claim 54 wherein the composition has a pH less than about 2.

68. The process of claim 54 wherein the composition is substantially free of added hydroxylamine, nitrate, persulfate or any combination of two or more thereof.

69. The process of claim 54 wherein the etching composition is selective for etching high oxygen content silicon oxynitride, silicon dioxide and silicate glasses over silicon nitride, titanium nitride and silicon.

70. The process of claim 69 wherein the silicon comprises one or more of amorphous silicon, polysilicon and monocrystalline silicon.

71. The process of claim 54 wherein the composition is substantially free of added water and/or is anhydrous.

72. The etching composition of claim 40 wherein the composition is substantially free of added water and/or is anhydrous.

73. A selective wet etching composition, comprising:
from about 40 wt. % to about 80 wt. % of a phosphonic acid or a phosphinic acid or a mixture of any two or more thereof;
from about 0.1 wt. % to about 40 wt. % of a fluoride; and
less than about 30 wt. % of water.

74. The etching composition of claim 73 wherein the phosphonic acid comprises a C₁-C₁₀ branched or unbranched alkyl or C₆-C₂₄ aryl or C₁-C₁₀ branched or unbranched alkyl-substituted C₇-C₃₆ aryl phosphonic acid.

75. The etching composition of claim 73 wherein the phosphinic acid comprises a C₁-C₁₀ branched or unbranched alkyl or C₆-C₂₄ aryl or C₁-C₁₀ branched or unbranched alkyl-substituted C₇-C₃₆ aryl phosphinic acid.

76. A process of selectively etching oxide relative to nitride, metal, silicon or silicide, comprising:
providing a substrate comprising oxide and one or more of a nitride, a high-nitrogen content silicon oxynitride, a metal, silicon or a silicide in which the oxide is to be etched;
applying to the substrate for a time sufficient to remove a desired quantity of oxide from the substrate an etching composition comprising:
from about 40 wt. % to about 80 wt. % of a phosphonic acid or a phosphinic acid or a mixture of any two or more thereof;
from about 0.1 wt. % to about 40 wt. % of a fluoride; and
less than about 30 wt. % of water; and
removing the etching composition;
wherein the oxide is removed selective to the one or more of nitride, high-nitrogen content silicon oxynitride, metal, silicon or silicide.

77. The process of claim 76 wherein the phosphonic acid comprises a C₁-C₁₀ branched or unbranched alkyl or C₆-C₂₄ aryl or C₁-C₁₀ branched or unbranched alkyl-substituted C₇-C₃₆ aryl phosphonic acid.

78. The process of claim 76 wherein the phosphinic acid comprises a C₁-C₁₀ branched or unbranched alkyl or C₆-C₂₄ aryl or C₁-C₁₀ branched or unbranched alkyl-substituted C₇-C₃₆ aryl phosphinic acid.
